(19) United States
(12) Patent Application Publication
(10) Pub. No.: US 2003/0097546 A1
(43) Pub. Date: May 22, 2003

(54) Reconfigurable processor

(76) Inventor: Richard Taylor, Bristol (GB)

Correspondence Address: HEWLETT-PACKARD COMPANY, Intellectual Property Administration, P.O. Box 272400, Fort Collins, CO, 80527-2400, US

(21) Appl. No.: 10/299,395

(22) Filed: Nov. 19, 2002

(30) Foreign Application Priority Data
Nov. 20, 2001 (GB) 0127727.6

(51) Int. Cl. G06F 9/00

(52) U.S. Cl. 712/226

(57) ABSTRACT

Data processing apparatus comprises an instruction test module (10) which receives an instruction stream (12) comprising a stream of instructions required to be executed. The instruction test module (10) uses a content addressable memory (14) to detect whether an instruction in the instruction stream (12) can be executed by existing non-reconfigurable or by reconfigurable logic configured by a software routine, or not at all (i.e. an error condition). The content addressable memory (14) returns one of several responses, namely the original instruction (in the case that it is available in hardware), a jump/sub instruction (for access to the software routine), the software routine itself (i.e. insertion of additional instructions into the instruction stream 12), or a code/sub routine call for an error handling routine.

### FIELD OF THE INVENTION

This invention relates generally to integrated circuit computing devices, and more specifically, to an integrated circuit computing device comprising a dynamically configurable and/or reconfigurable element to provide additional processing capabilities.

### BACKGROUND TO THE INVENTION

The microprocessor has evolved over many years to become a very complex and powerful general purpose processor, capable of high levels of performance due to the large amount of circuitry and firmware dedicated to complex, high level functions. These high power, complex, general purpose microprocessors are known as Complex Instruction Set Computers (CISC), due to the provision of features which permit execution of complex instructions.

In order to increase the speed at which functions are performed, the special purpose, complex circuitry and firmware of the CISC was eliminated, to produce a Reduced instruction Set Computer (RISC). The RISC architecture is concerned with implementing each instruction within a simple instruction set in a single clock cycle. Thus, the RISC is arranged to perform fewer functions than the CISC, but those functions it is arranged to perform can be performed very quickly. As a result of the reduced, simplified instruction set, the amount of circuitry in a RISC is substantially less than that used in a CISC.

On the other hand, complex operations carried out by software can, in themselves, be relatively time-consuming and U.S. Pat. No. 5,600,845 is concerned with the increase of computer speed by executing a substantial number of such time-consuming functions in hardware instead. It is this approach which is adopted for special purpose microprocessors and which suits them so well to their specific intended tasks. However, from a practical point of view, it is virtually impossible to make a general-purpose microprocessor with all conceivable high-level functions implemented in hardware and/or firmware. Constraints on semiconductor die size and system architecture make the building of a general purpose microprocessor which directly provides a large variety of high-level, complex functions impractical.

U.S. Pat. No. 5,600, 845 discloses an integrated circuit computing device which comprises a dynamically configurable Field Programmable Gate Array (FPGA). The gate array is configured to implement a RISC processor and a reconfigurable instruction execution unit. Programmable logic devices are generally well known in the electronics art, and have progressed from simple AND-OR arrays to very complex Field Programmable Gate Arrays (FPGA's), which have a large number of input/output (I/O) blocks, programmable logic blocks and programmable routing resources to interconnect the logic blocks to each other and the I/O blocks. The vast majority of applications for a typical FPGA are for combinatorial logic functions and the like. The dynamic reconfigurability of the FPGA enables the reconfigurable instruction execution unit in the arrangement described in U.S. Pat. No. 5,600,845 to be dynamically changed to implement complex operations in hardware rather than in time-consuming software routines. However, this type of arrangement still requires a preconfigured instruction set for use in executing the incoming instructions and, if an instruction is not present in the instruction set, the instruction is treated as an ‘exception’.

In general, processor designers need to account for unusual, unexpected or undesirable occurrences within a program, and it is generally necessary to provide a planned course of action for every possibility. If an action has not been planned, unintended results will occur. These results may vary from, for example, an incorrect number being logged to attempted execution of data, and may produce disastrous consequences. Unusual, but possible, occurrences are called ‘exceptions’. As an example, it may be desirable to include means for checking for arithmetic exceptions. If the result of an addition, subtraction, multiplication or division is too large for the available number of bits, there is an overflow and the programmer would probably want to include a special action to process such an event. Many different types of exception are known and may be accounted for according to programmer and user requirements.

Many different arrangements are known for dealing with exceptions. For example, U.S. Pat. No. 5,386,563 describes data processing apparatus in which a central processing unit (CPU) is operable in either a main processing mode or an exception processing mode. The CPU has a plurality of main data registers and a processing status register for use in the main processing mode. Upon entering the exception processing mode, at least one exception data register is substituted for use in place of a respective corresponding one of the main data registers and the data held within the processing status register is stored within a saved processing status register. When the exception processing mode is left, the main data registers are returned for use in place of the exception data registers and the data stored within the saved processing status register is restored to the processing status register. A plurality of exception processing modes are described, each having their own associated exception data registers. When a further differing exception occurs within an exception processing mode, the CPU switches to that further differing exception processing mode and uses its own exception data registers and saved processing status register in place of those of the existing processing mode. In this way, nested exception processing is achieved.

In the arrangement described in U.S. Pat. No. 5,701,493, a CPU architecture is provided having a user mode, a plurality of exception modes and a system mode entered via one of the exception modes. The system mode re-uses the same set of registers as-the user mode and yet has access to a set of privileged resources compared to the standard resources of the user mode. Interrupts of the same type (or a lower level of priority) are disabled when the system is already in that exception mode, but are re-enabled when the system is moved into the system mode. Branch instructions may be used in the user and system modes, but not the exception modes.

U.S. Pat. No. 6,216,222 describes an arrangement for handling exceptions in a pipelined data processing apparatus. In a pipelined processor, an instruction execution is broken up into a sequence of cycles, also called phases or stages, each of which can be overlapped with the cycles of another instruction execution sequence in order to improve performance. For example, consider a reduced instruction set computer (RISC) type of processor that uses three basic pipeline cycles, namely, an instruction fetch cycle, a decode cycle, and an execute cycle which includes a write back to the register file. In this 3 -stage pipelined processor, the execute cycle of one instruction may be overlapped with the decode cycle of the next instruction and the fetch cycle of the instruction following the instruction in decode. To maintain short cycle times, i.e. high clock rates, the logic operations done in each cycle must be minimised and any required memory accesses kept as short as possible. In addition, pipelined operations require the same timing for each cycle with the longest timing path for one of the pipeline cycles setting the cycle time for the processor.

In the arrangement of U.S. Pat. No. 6,216,222, there is provided an execution unit having a plurality of pipelined stages for executing instructions, such that a maximum of ‘n’ can be being executed simultaneously within the execution unit. Further, a set of ‘n’ logical exception registers are provided, each exception register being capable of storing a number of exception attributes associated with an instruction for which an exception has been detected during execution by the execution unit. In the event of an exception being detected during execution of a first instruction, the execution unit is arranged to: (i) store in a first of the exception registers the exception attributes associated with the first instruction; and (ii) continue executing any remaining instructions already in the pipelined stages at the time the exception was detected. The execution unit is further arranged to store in the exception registers the exception attributes associated with any of the remaining instructions for which an exception is detected during execution, whereby the exception attributes stored in the exception registers can be provided to an exception processing tool for use in recovering from any exceptions occurring during processing of the first instruction and the remaining instructions. By this approach, when the exception processing tool is invoked, then it can deal with any exceptions arising from the instructions executed by the pipeline, and the data processing apparatus can then continue with the next instruction, without the need to re-execute any of the instructions that were in the pipeline at the time the first exception was detected.

However, the designer of a processor cannot be expected to anticipate and take into consideration all conceivable operations, and it is likely that the processor will be required to execute instructions not anticipated by the processor's original designers. In addition, conventional arrangements for handling exceptions on “illegal” instructions are both slow and non-uniform, and they expose the programmer to the core processor mechanism.

We have now devised an arrangement which seeks to overcome the problems outlined above, and provide an improved data processing apparatus having improved data processing capabilities.

### SUMMARY OF THE INVENTION

In accordance with the present invention, there is provided data processing apparatus consisting of one or more non-reconfigurable devices connected thereto or incorporated therein, and a set of programmable devices which can be selectively configured and/or reconfigured by means of one or more respective software routines to execute one or more of a plurality of different instructions as part of an instruction set or stream, the apparatus being configured to receive from said instruction set or stream an instruction for execution, compare, during execution of said instruction set or stream, said instruction with the contents of an instruction set or list to determine whether or not said instruction can be executed by any of said non-reconfigurable hardware devices, and, if not, determine if a predefined configuration of said programmable devices exists to enable them to execute said instruction, and if not, determine if a software routine exists for reconfiguring said programmable devices to enable them to execute said instruction and, if such a software routine exists, replace said instruction in the instruction set or stream being executed with said software routine or one or more pointers thereto or replace said instruction in said instruction set or stream being executed with an error handling routine or a call thereto.

Also in accordance with the present invention, there is provided a method, of data processing, comprising the steps of providing apparatus consisting of one or more non-reconfigurable hardware devices and a set of programmable devices which can be selectively configured and/or reconfigured by means of one or more respective software routines to execute one or more of a plurality of different instructions as part of an instruction set or stream, receiving from said instruction set or stream an instruction for execution, and, during execution of said instruction set or stream, comparing said instruction with the contents of an instruction set or list to determine whether or not said instruction can be executed by any of said non-reconfigurable hardware devices and, if not, determining if a predefined configuration of said programmable devices exists to enable them to execute said instruction, and, if not, determining if a software routine for enabling said programmable devices to execute said instruction exists and, if such a software routine exists, replacing said instruction in said instruction set or stream with said software routine or one or more pointers thereto or replacing said instruction in said instruction set or stream with an error handling routine or a call thereto.

Thus, during execution of the instruction set or stream (i.e. during “run-time”), when an instruction is received, the apparatus first checks to see whether it can be executed directly by existing, permanent, hard-wired, non-reconfigurable hardware incorporated in or connected to the data processing apparatus. Instructions which can be executed in this manner are stored as an instruction set in, for example, a memory device of the apparatus. If the instruction is determined to be executable by the hardware, the instruction is so executed and the apparatus moves on to the next instruction. If, however, the instruction cannot be executed by the hardware, the apparatus must follow an alternative course of action. In the case of the present invention, there will also be a memory means for storing previously-defined configurations of the programmable devices enabling them to execute one or more of a plurality of different instructions. The apparatus checks these stored software routines to see whether the instruction in question can be executed by the programmable devices using a configuration which is already defined and stored in the apparatus or available for use thereby. If so, the instruction is executed by the programmable devices and the apparatus moves on to the next instruction. If, however, a suitable configuration has not been previously defined and stored, the apparatus is arranged to either replace the instruction with an error handling routine (as in prior art systems when an instruction cannot be executed), or go to a software routine (if one is available) which reconfigures the programmable devices to enable them to execute the instruction. This process is carried out dynamically while the instrucrtion set or stream is being executed.

It should be borne in mind that the apparatus is likely to have limited memory space therein for storing configurations which enable the programmable devices to execute instructions. As such, if a configuration for executing a particular instruction is not already stored therein, the programmable devices may need to be dynamically reconfigured by a predefined software routine available for use by the apparatus. However, this not only takes a predetermined amount of time, which may slow the processing capability of the apparatus down by an unacceptable large amount, but the new configuration is also likely to replace another configuration which is already stored in the allocated memory space therefor. As such, the apparatus of the invention is preferably adapted to make the decision between reconfiguring the programmable devices and entering an error handling routine on the basis of one or more of the following considerations:

How likely is the newly-defined configuration to be used again (or how often)? In order to determine this, the apparatus may include means for looking ahead at future instructions to be executed.

How likely is an existing configuration (which would be replaced by a newly-defined configuration) to be used again (or how often)? Again, the apparatus can look ahead at future requirements to assess this.

How long will it take to reconfigure the programmable devices to execute the instruction? Will it slow the processing down more than the use of an error handling routine?

The decision-making process is similar in many respects to an instruction cache. It operates largely on the basis that optimisation of time is required and, as such, there are many different types of algorithm known in the art to execute such a decision-making process, such as the “Least Recently Used” (LRU) algorithm.

It will be understood, that the data processing apparatus itself includes the means for interpreting the instruction and replacing it during run-time with a software routine for reconfiguring the programmable devices to enable them to execute the same instruction, in the event that an instruction is determined not to be executable by a piece of hardware incorporated in or connected to the data processing apparatus or an existing programmable device configuration previously stored therein. In one preferred embodiment of the invention, the apparatus includes means for inserting one or more pointers into the incoming data stream which point to the memory location of the software routine required to be executed to reconfigure the programmable devices.

In a preferred embodiment of the present invention, means are provided for updating said data processing apparatus in the event that an instruction is received which is not present in said instruction set, to include the programmable device configuration to handle such an instruction if it is received again in the future.

It will be apparent that the instructions primarily envisaged to be affected by the present invention are ‘programmable instructions’. In systems based around “programmable devices” often implemented by field programmable logic, the circuitry is made up of a plurality of transistors or similar devices, the connections therebetween not being fixed by design. Instead, such connections are resettable and changeable according to the nature of instructions being received by the data processing apparatus. Such instructions, which prompt the reconfiguration of the transistor connections are known as programmable instructions. If, when such instructions are received, they are not present in the instruction set, they can be replaced or executed by the programmable hardware configured using the resettable connections between the transistors.

Some such systems use so-called ‘floating point’ solutions, which relate to a particular type of arithmetic operation. However, in conventional floating point systems, if the required transistors are being used to execute a previously-received programmable instruction (particularly in a pipelined processor, whereby one instruction may be executed while another is being decoded and yet another is being fetched) the current instruction must be delayed or ‘trapped’ to await execution, which slows the entire system down. On the other hand, in the case of the present invention, the apparatus is made more efficient by the means for replacing the instruction with a software routine which configures a set of programmable devices so that the instruction can be executed with less delay and inconvenience to the overall system. In other words, the present invention overcomes the problem whereby the dynamic nature of programmable instructions may mean that hardware to implement an instruction may be present at one point and not at another, because the embedded technologies which typically make use of technology of this type have highly non-predictable instruction mixes which poses a potential problem when conventional exception-driven design is used.

In general, the present invention provides a system including field programmable logic which can be used to provide additional processing capabilities which may not have been anticipated by the original designer(s) of the data processing apparatus, and such additional capabilities can be represented by additional instructions which were not anticipated by the original designer(s) of the data processing apparatus when the apparatus was being designed. Overall, the present invention provides a way of augmenting a processor having a conventional instruction set with field programmable logic.

In one embodiment, the present invention is implemented by means of one or more pipeline stages within the data processing apparatus, which affects latency (by perhaps introducing a single cycle delay, assuming that the instructions themselves are working in a single cycle) but not throughput. However, the addition or otherwise of one or more additional pipeline stages is dependent on the position of the apparatus of the present invention within the overall system. In fact, the apparatus may include a pre-fetch unit which allows instructions to be brought in faster than the CPU can process them.

### BRIEF DESCRIPTION OF THE DRAWINGS

An embodiment of the present invention will now be described by way of example only and with reference to the accompanying drawing, in which:

FIG. 1 is a schematic block diagram illustrating an exemplary embodiment of data processing apparatus according to the present invention.

### DETAILED DESCRIPTION OF THE INVENTION

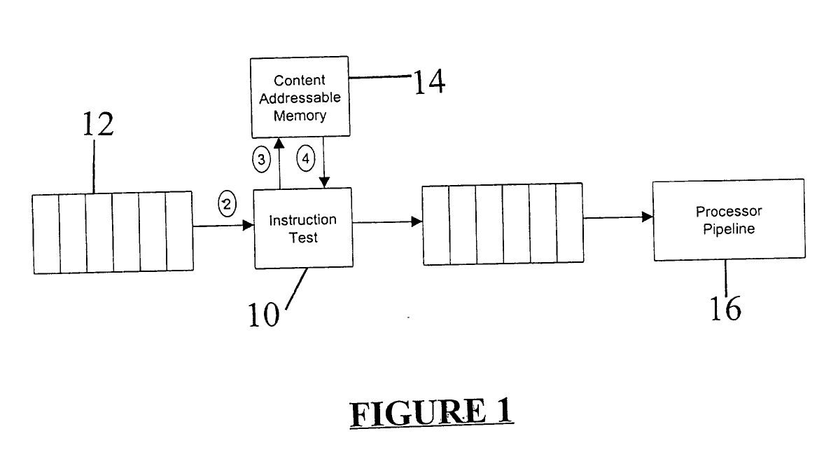

Referring to FIG. 1 of the drawings, data processing apparatus according to an exemplary embodiment of the present invention comprises a logical instruction test module 10 which receives an instruction stream 12 comprising a stream of instructions required to be executed.

The instruction test module 10 includes a memory device 14 in which is stored a predicted instruction set indicating instructions which can be executed by any non-reconfigurable hardware in the system and any stored software for configuring a set of programmable devices (comprising a pool of logic gates which can be configured and reconfigured as required) to execute one or more instructions.

In use, each instruction received by the data processing apparatus while an instruction set or stream is being executed thereby, is compared against the contents of the memory 14. If an instruction is present therein, it simply proceeds down the system pipeline for execution. However, the apparatus also includes mappings from instructions not included in the predicted instruction set to at least one of the following:

a) a subroutine which implements the instruction;

2) a trap/exception handler which handles the instruction;

3) one or more logic configurations which represent the instruction and its interface to the core processor (the number of logic configurations being dependent upon a time-space tradeoff within the FPGA design);

4) a stream of equivalent instructions.

In a preferred embodiment of the invention, a pipeline stage following (immediately or otherwise) the instruction “fetch” stage or an instruction cache controller maintain a table of entries corresponding to some or all instructions available to the compiler of the object bode within the data process apparatus. Such instructions may take the form of a triplet, i.e. <instruction name, present flag, alternative>. The “alternative” may, for example, be a single instruction, a stream of instructions, a pointer to some other instruction or stream of instructions, or one or more of any other suitable alternative action.

The apparatus may use a content addressable memory 14 to detect whether an instruction in the instruction stream 12 exists at that time in hardware, as a software routine configuring the field programmable logic devices or not at all (i.e. an error condition), although several other techniques for performing this function are envisaged. A content addressable memory (or CAM) is very well known in the art. It comprises a memory having two fields: a search field and an address field. It is adapted to search only the search field for an incoming instruction and return one of two outputs, namely “execute” if the instruction if found or “exception” if it is not. The advantage of a content addressable memory is the single-loop search procedure described above. This procedure substantially optimises the speed at which the existing instruction set can be searched and a search result obtained. In other words, the search of a content addressable memory is performed in parallel—no matter how many entries are required to be searched, the search time remains the same. The result of the search is returned in a single cycle.

However, there are many other types of memory configurations and methods of searching them known in the art. For example, a conventional RAM may be used in conjunction with a software routine for searching the memory. The memory might have n locations in which an instruction is stored. Thus the software routine might be of the form:

| | |
|---|---|
| For | i = 1 to n |
| | SEARCH FOR INSTRUCTION X |
| If yes | EXECUTE |
| If no | GO TO EXCEPTION; |

However, this option does tend to be relatively slow because the minimum search speed is proportional to the number of entries n, so the content addressable memory is preferred.

In either case, however, the memory search process returns an output “execute”, which causes the instruction to be executed either by the hardware or the programmable devices configured by an existing software routine; or it returns “exception” which results in a decision-making algorithm being executed to decide whether to reconfigure the programmable devices to execute the instruction by defining a new software routine or to enter a conventional error handling subroutine. The decision is made on the basis of the following considerations:

How likely is the newly-defined configuration to be used again (or how often)?

In order to determine this, the apparatus may include means for looking ahead at future instructions to be executed.

How likely is an existing configuration (which would be replaced by a newly-defined configuration) to be used again (or how often)? Again, the apparatus can look ahead at future requirements to assess this.

How long will it take to reconfigure the programmable devices to execute the instruction? Will it slow the processing down more than the use of an error handling routine?

The decision-making process is similar in many respects to an instruction cache. It operates largely on the basis that optimisation of time is required and, as such, there are many different types of algorithm known in the art to execute such a decision-making process.

In this embodiment, the content addressable memory 14 returns one of several responses, namely the original instruction (in the case that it is available in hardware), a “jump-to-subroutine” instruction (for access to the software routine), the software routine itself (i.e. insertion of additional instructions into the instruction stream 12), or a code/subroutine call for an error handling routine (during which it is decided to define a new software routine to configure the programmable devices or enter an error handling subroutine).

The memory output (which may, of course, comprise the original instruction unchanged) is written out to the processor pipeline 16 and the rest of the processor pipeline carries on as normal.

When a new software routine is defined to configure the programmable devices, i.e. when a new instruction is introduced to the processor, the content addressable memory 14 is rewritten to reflect the loss of a particular instruction and the gain of a new one. As a supplementary side effect, a counter may be retained within the content addressable memory 14 unit which can be used to trigger the reconfiguration of the instruction set dynamically when too many instruction ‘misses’ occur, although once again several other configurations for performing the same function are envisaged.

The pipeline stage (or cache controller) compares the output of the memory 14 and is preferably arranged to do one of the following three things:

1) nothing (the instruction is present and no intervention is required);

2) replacement of the instruction with, for example, a suitable subroutine or trap alternative (i.e. the use of field programmable logic to implement the instruction in hardware, or an error handling routine as in conventional systems);

3) replacement of the instruction with one or a sequence of instruction equivalents (i.e. equivalent software), in which case the program counter may be suspended and a shadow PC or the like brought into play.

In one embodiment of the invention, in the event that a received instruction is determined not to be present in the instruction set and is determined not to be executable in hardware, it may be replaced by a look-up table with a call (or pointer) to a subroutine which simulates the instruction in software. Such a subroutine can be advanced into the system pipeline to fit planned memory accesses. As such, the present invention enables dynamic instructions to be composed, used and disposed of as required in a manner which is transparent to the programmer. In other words, the present invention hides the detail to which the programmer would otherwise be exposed in prior art systems, and enables backward compatibility through the dispersal of software upgrades to soft functions.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. Data processing apparatus consisting of one or more non-reconfigurable devices connected thereto or incorporated therein, and a set of programmable devices which can be selectively configured and/or reconfigured by means of one or more respective software routines to execute one or more of a plurality of different instructions as part of an instruction set or stream, the apparatus being configured to receive from said instruction set or stream an instruction for execution, compare, during execution of said instruction set or stream, said instruction with contents of an instruction set or list to determine whether or not said instruction can be executed by any of said non-reconfigurable hardware devices, and, if not, determine if a predefined configuration of said programmable devices exists to enable them to execute said instruction, and if not, determine if a software routine exists for reconfiguring said programmable devices to enable them to execute said instruction and, if such a software routine exists, replace said instruction in the instruction set or stream being executed with said software routine or one or more pointers thereto or replace said instruction in said instruction set or stream being executed with an error handling routine or a call thereto.

2. Data processing apparatus according to claim 1, being further configured to update said data processing apparatus in the event that an instruction is received which is not executable in existing hardware, so as to include a programmable device configuration to handle such an instruction if it is received again.

3. Data processing apparatus according to claim 1, wherein said programmable devices are implemented by field programmable logic.

4. Data processing apparatus according to claim 1, implemented by means of one or more pipeline stages.

5. Data processing apparatus according to claim 1, wherein, in the event that a received instruction is determined not to be executable by said non-reconfigurable devices, it is replaced by a look-up table or call (or pointer) to a software routine or other apparatus for configuring the programmable devices to execute the instruction.

6. Data processing apparatus according to claim 1, including apparatus for maintaining a table of entries corresponding to at least some of the instructions available to the data processing apparatus.

7. Data processing apparatus according to claim 6, wherein said instructions take the form of a triplet, i.e. <instruction name, present flag, alternative>.

8. Data processing apparatus according to claim 6, wherein said apparatus for maintaining a table of entries comprises a pipeline stage or a cache controller.

9. Data processing apparatus according to claim 1, wherein said instruction set is stored in a content addressable memory.

10. A method of data processing, comprising the steps of providing apparatus consisting of one or more non-reconfigurable hardware devices and a set of programmable devices which can be selectively configured and/or reconfigured by means of one or more respective software routines to execute one or more of a plurality of different instructions as part of an instruction set or stream, receiving from said instruction set or stream an instruction for execution, and, during execution of said instruction set or stream, comparing said instruction with the contents of an instruction set or list to determine whether or not said instruction can be executed by any of said non-reconfigurable hardware devices and, if not, determining if a predefined configuration of said programmable devices exists to enable them to execute said instruction, and, if not, determining if a software routine for enabling said programmable devices to execute said instruction exists and, if such a software routine exists, replacing said instruction in said instruction set or stream with said software routine or one or more pointers thereto or replacing said instruction in said instruction set or stream with an error handling routine or a call thereto.

11. A computer program for performing the method of claim 10.

12. Data processing apparatus configured to perform the method of claim 10.

13. Data processing apparatus consisting of one or more non-reconfigurable devices connected thereto or incorporated therein, and a set of programmable devices which can be selectively configured and/or reconfigured by means of one or more software routines to execute one or more of a plurality of different instructions, the apparatus being configured to receive an instruction for execution, compare said instruction with contents of an instruction set or list to determine whether or not said instruction can be executed by any of said non-reconfigurable hardware devices and, if not, determine if a predefined configuration of said programmable devices exists to enable them to execute said instruction and, if not, determine if a software routine exists for reconfiguring said programmable devices to enable them to execute said instruction and, if such a software routine exists, replace said instruction with said software routine or one or more pointers thereto, or replace said instruction with an error handling routine or call thereto, the apparatus being further configured to update said data processing apparatus in the event that an instruction is received which is not executable in existing hardware, so as to include a programmable device configuration to handle such an instruction if it is received again.

14. Data processing apparatus consisting of one or more non-reconfigurable devices connected thereto or incorporated therein, and a set of programmable devices which can be selectively configured and/or reconfigured by means of one or more software routines to execute one or more of a plurality of different instructions, the apparatus being configured to receive an instruction for execution, compare said instruction with contents of an instruction set or list to determine whether or not said instruction can be executed by any of said non-reconfigurable hardware devices and, if not, determine if a predefined configuration of said programmable devices exists to enable them to execute said instruction and, if not, determine if a software routine exists for reconfiguring said programmable devices to enable them to execute said instruction and, if such a software routine exists, replace said instruction with said software routine or one or more pointers thereto, or replace said instruction with an error handling routine or call thereto, wherein, in the event that a received instruction is determined not to be executable by said non-reconfigurable devices, it is replaced by a look-up table or call (or pointer) to a software routine or other apparatus for configuring the programmable devices to execute the instruction.

15. Data processing apparatus consisting of one or more non-reconfigurable devices and a set of programmable devices which can be selectively configured by means of one or more respective software routines to execute one or more of a plurality of different instructions, the apparatus being configured on receipt of an instruction in a stream of instructions for execution to determine whether or not said instruction can be executed by any of said non-reconfigurable hardware devices, and, if not, to determine if a predefined configuration of said programmable devices exists to enable them to execute said instruction, and if not, to determine if a software routine exists for reconfiguring said programmable devices to enable them to execute said instruction and, if such a software routine exists, replace said instruction with said software routine or one or more pointers thereto, all while executing said stream of instructions.

16. A method of data processing, comprising the steps of providing one or more non-reconfigurable hardware devices and a set of programmable devices which can be selectively configured by means of one or more respective software routines to execute one or more of a plurality of different instructions, receiving an instruction in a stream of instructions for execution, and, during execution of said stream, determining whether or not said instruction can be executed by any of said non-reconfigurable hardware devices and, if not, determining if a predefined configuration of said programmable devices exists to enable them to execute said instruction, and, if not, determining if a software routine for enabling said programmable devices to execute said instruction exists and, if such a software routine exists, replacing said instruction in said instruction set or stream with said software routine or one or more pointers thereto.
